(19) United States
(12) Patent Application Publication
(10) Pub. No.: US 2012/0321479 A1
(43) Pub. Date: Dec. 20, 2012

(54) METHOD FOR PRODUCTION OF A ROTOR BLADE FOR A WIND TURBINE GENERATOR AND A ROTOR BLADE

(76) Inventors: Thomas Bruun, Randers SO (DK); Maja Rose Wieland, Brabrand (DK)

(21) Appl. No.: 13/578,305

(22) PCT Filed: Feb. 10, 2011
(86) PCT No.: PCT/DK11/50036

§ 371 Date: Aug. 28, 2012

(30) Foreign Application Priority Data
Feb. 12, 2010 (DK) PA 2010 70052

(51) Int. Cl. B32B 37/02; F03D 1/06; B05D 3/12; B32B 38/04; B05D 5/00

(52) U.S. Cl. 416/226; 156/148; 427/289

(57) ABSTRACT

A method of production of a rotor blade (15) for wind turbine generator (WTG) is disclosed using a load carrying structure or spar (10) extending from the root end of the rotor blade (15) towards the tip end of the rotor blade (15), and comprising: applying pre-shaped foam members (11 and 12) to the load carrying structure or spar (10) to build up a desired outer blade configuration, removing or adding foam material to obtain a desired outer blade configuration, coating the outer surface of the rotor blade with a material providing a smooth and rigid surface shell (16) structure, and finishing the outer surface shell (16) of the rotor blade (15) by grinding and optionally painting. Using only relative simple provisions a considerably more flexible manufacturing process is achieved with important advantages regarding the outer configuration of the rotor blades.

### CROSS REFERENCE TO RELATED APPLICATIONS

Reference is made to Published Patent Application WO 2011/098084 A1, International Filing Date of Feb. 10, 2011 and Danish Patent Application PA 2010 70052, filed Feb. 12, 2010, which applications are incorporated herein by reference in their entirety.

### BACKGROUND OF THE INVENTION

1. Field of the Invention

The present invention relates to a method for production of a rotor blade for a wind turbine generator (WTG).

The present invention furthermore relates to a rotor blade produced in accordance with the method according to the invention.

2. Description of the Prior Art

Rotor blades for WTG are produced by varying methods. It is common for the known methods to use a mould defining the outer geometric shape of the rotor blade.

Some known rotor blades are build up around a load carrying structure, which often is made by a system of tubular composite members having decreasing cross section as seen from the root end portion in the direction towards the tip end of the rotor blade. By other known rotor blades the outer rigid shell structure forms the load carrying structure being integrated with the root end part of the rotor blade.

U.S. Pat. No. 5,482,584 discloses a method for manufacturing rotor blades, where a rotor blade is made from fiber-reinforced synthetic resin and comprises a moulded core with central front and rear elements and a foot end fastening element, a unidirectional fiber layer wound longitudinally on the core, a first cross-binding lying over the fiber layer and a second cross-binding forming a covering for the entire assembly. The rotor blade blank, which is still unstable after the binding operation, reaches its final extended position in a bottom mould component. The mould is then closed by a top component and the rotor blade blank is pressed inside the closed mould. The fiber layer, which can be impregnated with resin are compressed in the pressing process, with the resin being squeezed into the gaps and surplus resin being squeezed out. After the pressing process, the rotor blade blank is cured in the mould and preferably heated during curing. The two mould components are preferably metal moulds which can be heated. Pressing with external pressure on the mould may create difficulties and incur high expenditure, particularly with rotor blades which are very long, such as longer than 12 m. Inflatable core elements in the form of hollow bodies are advantageous in such cases. The pressure in the mould can be built up by compressed air passing into the hollow bodies, which press the windings against the walls of the mould from the inside. Very little surface roughness is obtained if the surface of the rotor blade is coated with thermoplastic film. Such coating may be effected in the mould. For this purpose, the mould is lined with an appropriate pre-formed thermoplastic film, which is joined securely to the resin in the curing process. With a film inserted in the mould, it is unnecessary to apply release agent to the mould. The film can give the desired color and thus determine the final color of the rotor blade with white preferably being selected for thermal reasons. Rotor blades of the above-described type may be bound with pre-impregnated fibers. It is also possible to bind them dry and then impregnate the binding with the resin in known manner. For this purpose, a pressure below atmospheric may for example, be generated in the closed mould and the resin injected into it.

### SUMMARY OF THE INVENTION

The present invention is a new and improved method for production of rotor blades which, without the use of exterior mould parts, provide a considerably more flexible manufacturing process and provides very important advantages regarding the outer configuration of the rotor blades.

The method of the invention for the production of rotor blades includes the following method steps:
applying partial pre-shaped foam members to a load carrying structure or spar to build up a desired outer blade configuration;
coating an outer surface of a rotor blade with a material including a smooth and rigid surface shell structure; and
finishing the outer surface shell structure of the rotor blade by grinding and optional painting.

A considerably more flexible manufacturing process is achieved without the use of exterior mould parts by use of relatively simple steps to achieve a considerably more flexible manufacturing process and very important advantages regarding an outer configuration of the rotor blades.

Instead of using an ordinary expensive mould to define the exterior shape of the rotor blade, the exterior shape of the rotor blade is built up around the load carrying structure or spar in such a manner that the outer aerodynamic profile of the rotor blade is achieved by connecting individual pre-shaped foam members to the load carrying structure or spar.

After the almost desired exterior shape is obtained from the mould, it is necessary to treat the exterior shape by milling or grinding to achieve a satisfactory smooth and durable surface to be finished by furthermore applying a surface coating or paint.

Such surface coating may be applied in successive layers on top of the milled or grinded surface of the foam body of the rotor blade.

Preferably the pre-shaped foam material is applied by gluing to said load carrying structure or spar to build up a desired outer blade configuration.

Alternatively the foam material may be applied by spraying additional successive layers of foam material on the load carrying structure or spar in a controlled manner to build up a desired outer blade configuration.

The method according to the invention may include removal of foam material by cutting or milling to finish the blade to a desired outer configuration,

Alternatively, the foam material may be applied in successive pre-shaped layers or by gluing pre-shaped partial blocks to the load carrying structure or spar and to the outside of previously applied layers or blocks of foam material to build up a desired outer blade configuration.

Advantageously, the method according to the invention includes the following further steps:
obtaining a desired outer blade configuration by removing foam material under control of a computer-controlled robotic operated tool, to coat the outer surface of the rotor blade with a material to obtain a smooth and hard surface shell; and
finishing of the outer surface shell of the rotor blade by grinding and optionally painting is carried out under control of a computer-controlled robot.

The present invention also relates to a rotor blade for a wind turbine generator produced by the method according to the invention comprising a load carrying structure or spar extending from the root end of the rotor blade towards a tip end of the rotor blade, pre-shaped foam members applied to the load carrying structure or spar to form a desired outer blade configuration which configuration is shaped by removal or adding foam material to obtain the desired outer blade configuration, a coating material on the outer blade configuration to obtain an outer surface with a smooth and rigid surface shell which outer surface shell of the rotor blade may be finished by grinding and/or painting.

Preferably the rotor blade according to the invention comprises a load carrying structure or spar having decreasing cross sections relative to a root end of the rotor blade extending towards the tip end of the rotor blade wherein pre-shaped foam material is applied to the load carrying structure or spar by gluing to build up a desired outer blade configuration.

The rotor blade according to the invention may have foam material applied by spraying successive layers to said load carrying structure or spar in a controlled manner to build up a desired outer blade configuration.

Alternatively, the rotor blade according to the invention has the foam material applied by spraying successive pre-shaped layers or gluing pre-shaped partial blocks to the load carrying structure or spar and to the outside of previously applied layers or blocks of foam material to build up a desired outer blade configuration.

In order to automate production of the rotor blade according to the invention the rotor blade may have foam material removed or added with a computer-controlled robotic tool and coating of the outer surface of the rotor blade with a material to provide a smooth and rigid surface shell structure may also be carried out by a computer-controlled robotic operated tool, and finishing of the outer surface shell of the rotor blade by grinding and optionally painting also by a computer-controlled robot.

### BRIEF DESCRIPTION OF THE DRAWINGS

The invention is described in more detail in the following with reference to the drawing, in which:

FIG. 1 shows a plane sectional view of a traditional produced known rotor blade;

FIG. 2 shows an outline of an embodiment of a rotor blade according to the invention;

FIG. 3 shows a plane sectional view of a rotor blade according to the invention along the sectional line III-III of FIG. 2;

FIG. 4 shows a plane sectional view of a rotor blade according to the invention along the sectional line IV-IV of FIG. 2;

FIG. 5 shows a plane sectional view of a rotor blade according to the invention along the sectional line V-V of FIG. 2.

### DETAILED DESCRIPTION OF THE INVENTION

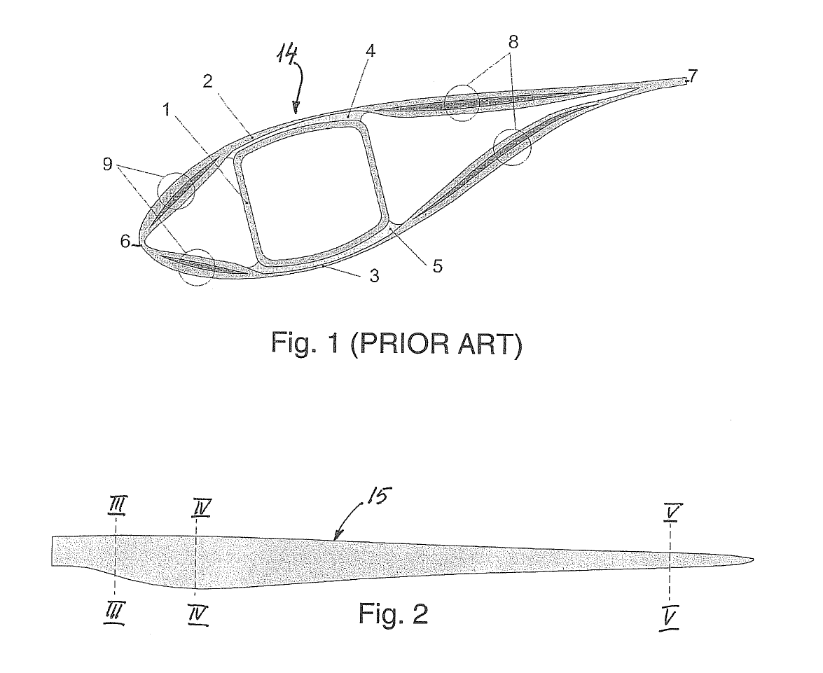

a prior art rotor blade 14 shown in FIG. 1 is produced in a mould defining the outer configuration of the rotor blade 14, which is made from a central load carrying spar 1 and two shells 2 and 3 made in the mould. The load carrying spar 1 is connected with the shells 2 and 3 by relative wide glue joints 4 and 5.

The shells 2 and 3 are directly interconnected by means of a glue joints at a leading edge 6 and a trailing edge 7 of the rotor blade 14. The shells 2 are built up as sandwich panels comprising interior foam cores 8 and 9.

FIG. 2 shows an outline of an embodiment of a rotor blade 15 according to the invention. Namely, a rotor blade 15, is produced without the use of a mould to define the outer configuration of the rotor blade 15.

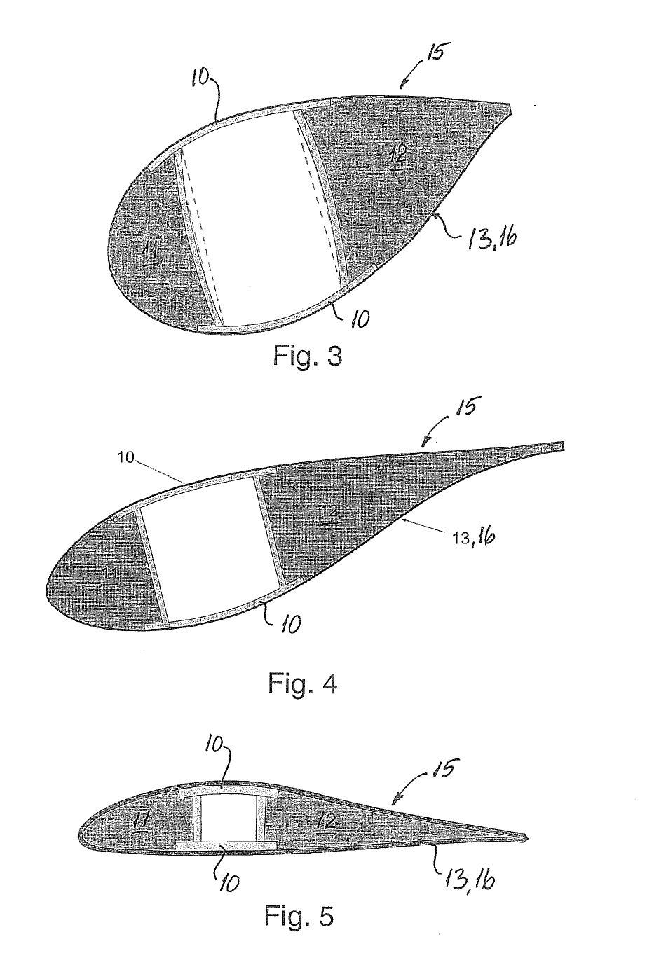

FIGS. 3-5 show sectional views of the rotor blade 15—as seen along sectional lines III-III, IV-IV and V-V, respectively as indicated in FIG. 2. The rotor blade 15 is built up around a load carrying structure or spar 10 and the outer configuration is achieved from foam material bodies 11 and 12 having varying shapes along the outline of the rotor blade 15.

As indicated by dotted lines in FIG. 3 the transverse part of the carrying structure or spar 10 may have a straight form between the opposite exterior parts of the carrying structure or spar 10.

The foam bodies 11 and 12 are connected to the load carrying structure or spar 10 either by gluing or by an integrated foaming-up process, where the foam bodies 11 and 12 are shaped and connected in one operation directly to the load carrying structure or spar 10.

As the configuration of the foam bodies 11 and 12 is not defined by an existing mould, it is possible to change the aerodynamic profile of the rotor blade 15 without the need of having a new production equipment.

At the respective sides of the carrying structure or spar 10, foam bodies may be applied in more layers and between the layers of foam bodies. Also, between side by side interconnected foam bodies use may be made of some form of interconnection or members which could be in the form of tongue and groove joints.

The foam bodies may be provided with hollow interiors in order to obtain a more lightweight rotor blade 15.

In order to obtain a smooth outer shape of the foam bodies 11 and 12 in an alternative manner, it is possible to arrange some form smoothening by heat treatment of the outer surface of the foam bodies 11 and 12 heated ironing to provide a smooth surface by melting in part the outermost layer of the foam bodies 11 and 12.

In order to achieve an optimal smooth outer surface on the rotor blade 15 and to obtain a rigid or solid outer shell 16, it may be necessary to apply one or more layers 13, which afterwards may be finished by a milling or grinding process.

In the case when the rigid outer shell 16 has layers 13, a core material may be between the layers which is a suitable foam material.

The surface shell may be reinforced by different types of fibers such as carbon or glass fibers.

By way of example, the foam material may be PET (polyethylene terephthalate), PVC (polyvinyl chloride) or PUR (polyurethane). The foam material may be reinforced by adding pieces of wood or plywood. The coating material may be a resin or polymeric material, such as polyester or epoxy.

Preferably, the load carrying structure or spar 10 is built up on a carrying mandrel system and made from a composite material which may be glass fiber/epoxy or a combination of glass fiber, carbon fiber and epoxy. Furthermore the load carrying structure or spar 10 may comprise honeycomb material or structures together with other types of fiber or polymers.

Alternatively, the load carrying structure or spar 10 may be built up by assembling pre-shaped members having stepwise decreasing cross sections viewed from the rod end towards the tip end of the carrying structure or spar 10 or from the tip end of the rotor blade.

The carrying structure or spar 10 may as a whole be supported either on a support surface or on a system of vertical uprights during the mounting of pre-shaped foam bodies at the outside surfaces of the carrying structure or spar 10.

A similar system of vertical uprights may be used for supporting the individual foam members during the hardening of the adhesives used either for connecting the individual foam members to the carrying structure or spar 10 or for connecting the individual foam members to the outside already mounted foam members.

Alternatively, foam bodies forming the leading side/edge of the rotor blade 15 may be built up on a support surface before the carrying structure or spar 10 as a whole is connected with the foam body. Afterwards, the foam body having individual foam bodies providing the trailing side/edge of the rotor blade 15 is connected to the opposite side of the carrying structure or spar 10.

The method for the production of a rotor blade according to the invention and the rotor blade according to the invention may be further modified within the spirit and scope of the invention.

The load carrying structure or spar extending from the root end to the tip end of the rotor blade to which the foam material or foam members are connected may be a rather slight construction. In that case, the outer rigid surface shell surrounding the foam body of the rotor blade may form the load carrying structure of the outer rigid surface shell.

1-11. (canceled)

12. A method for production of a rotor blade for a wind turbine generator including a load carrying tubular beam structure or spar with a decreasing cross section extending from a root end of the rotor blade towards a tip end of the rotor blade comprising:
applying pre-shaped foam members to the load carrying tubular structure or spar to form a desired outer blade configuration;
coating an outer surface of the rotor blade with a material providing a smooth and rigid surface shell structure; and
finishing the outer surface shell of the rotor blade by at least grinding.

13. A method according to claim 12, comprising:
gluing the pre-shaped foam members to an outer surface of the load carrying tubular structure or spar to form the desired outer blade configuration.

14. A method according to claim 12, comprising:
spraying the foam material in successive layers on the load carrying tubular structure or spar to form the desired outer blade configuration.

15. A method according to claim 12, comprising:
removing foam material by cutting or milling to finish the desired outer blade configuration.

16. A method according to claim 13, comprising:
removing foam material by cutting or milling to finish the desired outer blade configuration.

17. A method according to claim 14, comprising:
removing foam material by cutting or milling to finish the desired outer blade configuration.

18. A method according to claim 12, comprising:
applying the foam material in successive pre-shaped layers to the load carrying structure or spar or gluing pre-shaped partial blocks to an outside of the load carrying structure and to applied layers or blocks of the foam material to provide the desired outer blade configuration.

19. A method according to claim 12, comprising:
using a computer-controlled robotic tool to remove the foam material to obtain the desired outer blade configuration;
using a computer-controlled robotic tool to coat the outer surface of the rotor blade with a material providing a smooth and rigid surface shell structure; and
using a computer-controlled robotic tool to finish the outer surface shell of the rotor blade by grinding.

20. A rotor blade for a wind turbine generator comprising:
a load carrying structure or spar having a decreasing cross section viewed from a root end of a rotor blade towards a tip end of the rotor blade, preshaped foam members connected to the load carrying structure or spar to provide a desired outer blade configuration, a coating material on the desired outer blade configuration to provide an outer surface with a ground smooth and rigid surface shell structure.

21. A rotor blade according to claim 20, wherein:
the preshaped foam material is glued to an outside surface of the load carrying structure or spar to form the desired outer blade configuration.

22. A rotor blade according to claim 20, comprising:
successive layers of foam material disposed on the load carrying structure or spar to form the desired outer blade configuration.

23. A rotor blade according to claim 20, comprising:
pre-shaped layers or pre-shaped partial blocks glued to the load carrying structure and to previously applied layers or blocks of foam material to form the desired outer blade configuration.

24. A method in accordance with claim 12, comprising:

24. A method in accordance with claim 12, comprising:
painting the outer surface shell.

25. A method in accordance with claim 13, comprising:
painting the outer surface shell.

26. A method in accordance with claim 14, comprising:
painting the outer surface shell.

27. A method in accordance with claim 15, comprising:
painting the outer surface shell.

28. A method in accordance with claim 16, comprising:
painting the outer surface shell.

29. A method in accordance with claim 17, comprising:
painting the outer surface shell.

30. A method in accordance with claim 18, comprising:
painting the outer surface shell.

31. A method in accordance with claim 19, comprising:
painting the outer surface shell.

32. A rotor blade in accordance with claim 20, comprising:
a painted outer surface.

33. A rotor blade in accordance with claim 21, comprising:
a painted outer surface.

34. A rotor blade in accordance with claim 22, comprising:
a painted outer surface.

35. A rotor blade in accordance with claim 23, comprising:
a painted outer surface.

36. A rotor blade in accordance with claim 24, comprising:
a painted outer surface.
